(19) United States
(12) Patent Application Publication
(10) Pub. No.: US 2009/0007181 A1
(43) Pub. Date: Jan. 1, 2009

(54) TV SET, TV BROADCASTING RECEIVING SYSTEM, AND PROGRAM INFORMATION ACQUISITION METHOD USED IN TV SET

(75) Inventor: Kenji NAKAMURA, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/165,449

(22) Filed: Jun. 30, 2008

(30) Foreign Application Priority Data
Jun. 29, 2007 (JP) 2007-173048

(51) Int. Cl. H04N 5/44; H04N 5/445; H04N 7/173

(52) U.S. Cl. 725/50; 348/563; 725/131; 348/E05.099

(57) ABSTRACT

According to one embodiment, in a system formed by connecting a TV and an STB, the TV determines, in updating EPG information, whether the state of the TV allows EPG information acquisition. If the state does not allow EPG information acquisition, the TV requests the STB to acquire EPG information. When the EPG information acquisition request is received from the TV, and the state of the STB allows EPG information acquisition, the STB acquires EPG information and transmits the acquired EPG information (latest EPG information) to the TV. The TV updates the EPG information saved in a memory unit on the basis of the latest EPG information received from the STB.

### CROSS-REFERENCE TO RELATED APPLICATIONS

This application is based upon and claims the benefit of priority from Japanese Patent Application No. 2007-173048, filed Jun. 29, 2007, the entire contents of which are incorporated herein by reference.

### BACKGROUND

1. Field

One embodiment of the invention relates to a TV set which acquires program information contained in a TV broadcast wave, a TV broadcasting receiving system, and a program information acquisition method used in the TV set.

2. Description of the Related Art

In, e.g., recent terrestrial digital broadcasting, the digital broadcast wave of each channel contains the program information of a corresponding broadcasting station. In this case, to acquire the program information of a broadcasting station, it is necessary to receive the broadcast wave of the channel for a predetermined time or more. In analog broadcasting, for example, the broadcast wave of a specific channel provides the program information of each broadcasting station in a predetermined time zone. In this case, to acquire the program information, a TV set may receive the wave of the specific channel for a predetermined time or more in the predetermined time zone. However, in a use situation where a user is watching one channel for a long time, the TV set cannot acquire program information contained in the broadcast wave of another channel.

For example, Japanese Patent Application Publication (KOKAI) No. 2005-175788 proposes a system that allows a plurality of TV sets connected via a network to share the program information of other TV sets. However, the technique of this reference enables sharing of program information already held in the memories of other TV sets. Other TV sets do not always hold the latest EPG information. Additionally, when the number of TV sets connected to the network increases, a long time is necessary for a process of causing a TV set to detect the latest program information from pieces of program information held by the remaining TV sets.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the arrangement of a TV broadcasting receiving system according to an embodiment;

FIG. 2A is an exemplary flowchart for explaining an EPG information acquisition process (update process) in a TV according to the embodiment; and

FIG. 2B is an exemplary flowchart for explaining a process on the side of an STB according to the EPG information acquisition process in the TV shown in FIG. 2A according to the embodiment.

### DETAILED DESCRIPTION

Various embodiments according to the invention will be described hereinafter with reference to the accompanying drawings. In general, according to one embodiment of the invention, in a system formed by connecting a TV 1 and an STB 2, the TV 1 determines, in updating EPG information, whether the state of the TV allows EPG information acquisition. If the state does not allow EPG information acquisition, the TV 1 requests the STB 2 to acquire EPG information. When the EPG information acquisition request is received from the TV 1, and the state of the STB allows EPG information acquisition, the STB 2 acquires EPG information and transmits the acquired EPG information (latest EPG information) to the TV 1. The TV 1 updates the EPG information saved in a memory unit 111 on the basis of the latest EPG information received from the STB 2.

Embodiments of this invention will be described in detail with reference to the drawings.

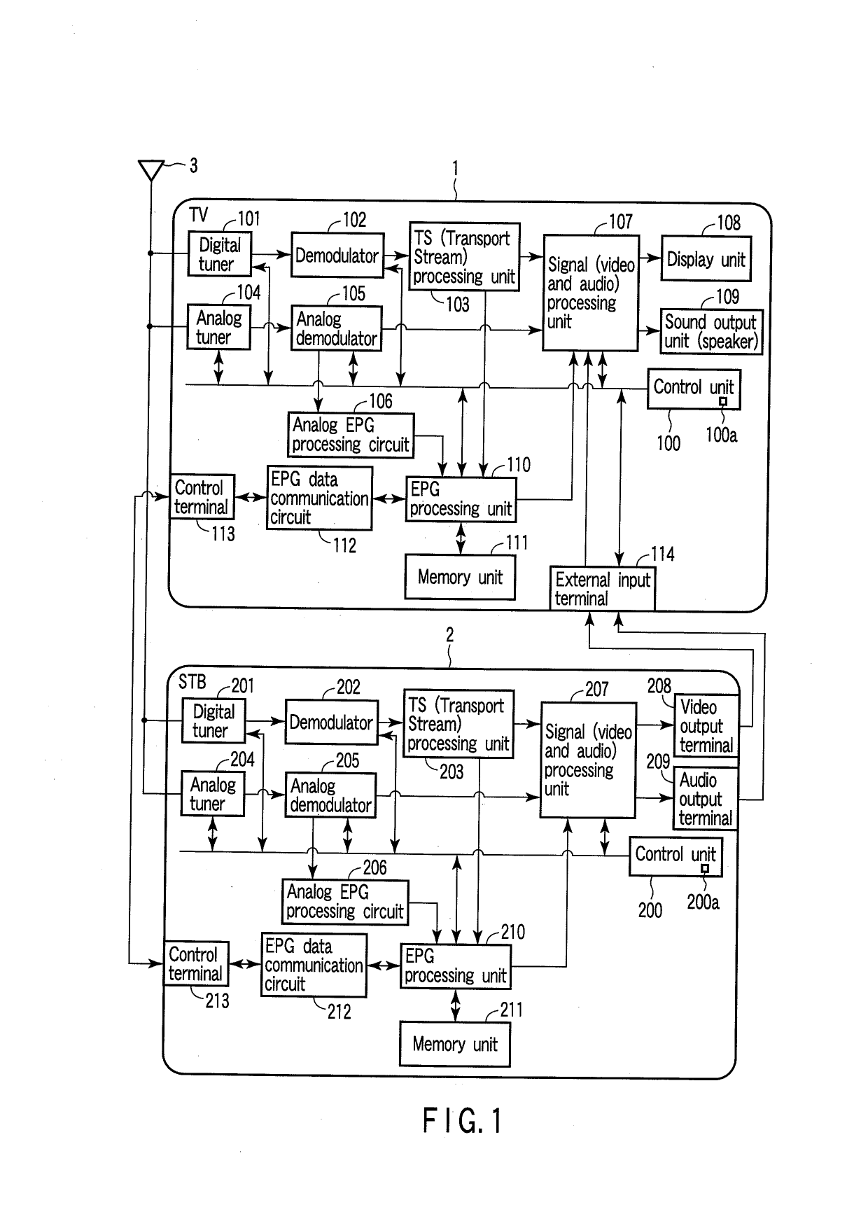

FIG. 1 is an exemplary block diagram showing an example of the arrangement of a TV broadcasting receiving system according to the embodiment. The TV broadcasting receiving system shown in FIG. 1 includes the television receiver (TV: television) 1 serving as a TV set, the peripheral device (STB: set top box) 2 serving as a TV set, and an antenna 3.

The television receiver (to be referred to as a TV hereinafter) 1 converts a broadcast wave received by the antenna 3 into a video signal and audio signal. Then, the TV 1 displays a video image on a display unit and outputs sound on the basis of the video signal and audio signal. The TV 1 also has a function of acquiring program information contained in the broadcast wave and displaying the program information on the display unit. The program information acquired by the TV 1 is called an electronic program guide (EPG). The EPG information is contained either in a digital broadcast wave or in an analog broadcast wave. In this embodiment, the broadcast wave of each broadcasting station (channel) contains the program information of the broadcasting station in digital broadcasting, and the broadcast wave of a specific channel that is broadcast in a specific time zone contains the program information of each broadcasting station in analog broadcasting.

The peripheral device (to be also referred to as an STB hereinafter) 2 is an electronic device having a function of acquiring the EPG information from the broadcast wave received by the antenna 3. Examples of the STB 2 are video devices such as a cable TV, BS/CS broadcasting receiver, DVD (Digital Versatile Disk) recorder, hard disk recorder, and AV (Audio Visual) personal computer. The STB 2 supplies a video signal and audio signal to the TV 1 and causes it to output a video image and sound. In this embodiment, the TV 1 and the STB 2 have a two-way communication function of transmitting and receiving EPG information and the like.

The arrangement of the television receiver (TV) 1 will be described next.

As shown in FIG. 1, the TV 1 includes a control unit 100, digital tuner 101, demodulator 102, transport stream (TS) processing unit 103, analog tuner 104, analog demodulator 105, analog EPG processing circuit 106, signal processing unit 107, display unit 108, sound output (speaker) unit 109, EPG processing unit 110, memory unit 111, EPG data communication circuit 112, control terminal 113, and external input terminal 114.

The control unit 100 controls the overall TV 1. The control unit 100 includes, e.g., a CPU, RAM (working memory), ROM (program memory), and nonvolatile memory. In the control unit 100, the CPU executes a control program stored in the ROM or nonvolatile memory, thereby implementing various kinds of processes. The control unit 100 has a timer 100a for measuring time and can therefore manage time.

The digital tuner 101 selects the digital broadcast wave of a specific channel from digital broadcast waves received by the antenna 3. The digital tuner 101 selects the digital broadcast wave of a channel designated by the control unit 100.

The demodulator 102 demodulates the digital broadcast wave of the channel selected by the digital tuner 101. The demodulator 102 is formed from, e.g., an OFDM (Orthogonal Frequency Division Multiplexing) demodulator or a PSK (Phase Shift Keying) demodulator. The demodulator 102 demodulates an MPEG TS signal from the digital broadcast wave.

The transport stream processing unit 103 executes a TS decoding process of the MPEG TS signal supplied from the demodulator 102. By the TS decoding process, the transport stream processing unit 103 extracts, from the digital broadcast wave of the channel selected by the digital tuner 101, the digital broadcast signal (digital video signal and digital audio signal) of a program that is being broadcast by the broadcasting station and various kinds of data (e.g., EPG information, program attribute information, and setting information) provided by the broadcasting station. The transport stream processing unit 103 outputs the digital video signal and audio signal obtained by the TS decoding process to the signal processing unit 107, and also outputs the EPG information obtained by the TS decoding process to the EPG processing unit 110.

The analog tuner 104 selects the analog broadcast wave of a specific channel from analog broadcast waves received by the antenna 3. The analog tuner 104 selects the analog broadcast wave of a channel designated by the control unit 100.

The analog demodulator 105 demodulates the analog broadcast wave of the channel selected by the analog tuner 104. The analog demodulator 105 outputs the demodulated signal to the signal processing unit 107 and the analog EPG processing circuit 106 as a broadcast signal (video signal and audio signal).

The analog EPG processing circuit 106 extracts EPG information from the signal demodulated by the analog demodulator 105. The analog EPG processing circuit 106 outputs the extracted EPG information to the EPG processing unit 110.

Under the control of the control unit 100, the signal processing unit 107 causes the display unit 108 to display a video image based on the video signal contained in the broadcast signal supplied from the transport stream processing unit 103 or the analog demodulator 105 and causes the sound output unit 109 to output sound based on the audio signal. The signal processing unit 107 also executes various kinds of image processing for the video image. For example, the signal processing unit 107 has an OSD (On Screen Display) composition function. With this function, the signal processing unit 107 receives, e.g., text information serving as program information from the EPG processing unit 110, converts the program information into display data, and displays the display data on the display unit 108.

The display unit 108 is a display device which displays a video image based on the video signal supplied from the signal processing unit 107. The sound output unit 109 is a speaker which outputs sound based on the audio signal supplied from the signal processing unit 107.

The EPG processing unit 110 manages EPG information. The EPG processing unit 110 includes, e.g., a CPU, RAM, ROM, and nonvolatile memory. In the EPG processing unit 110, the CPU executes a control program stored in the ROM or nonvolatile memory, thereby implementing various kinds of processes.

The memory unit 111 is a storage device for storing EPG information. The memory unit 111 is formed from, e.g., a rewritable nonvolatile memory.

The EPG data communication circuit 112 and the control terminal 113 serve as an interface for communication with the STB 2. For example, the EPG data communication circuit 112 and the control terminal 113 are formed from a dedicated port for transmitting and receiving EPG information and the like. However, a communication interface using an HDMI-CEC function or a communication interface using a network communication function such as a LAN may be used as the EPG data communication circuit 112 and the control terminal 113.

The EPG processing unit 110 executes a process of, e.g., saving, in the memory unit 111, EPG information acquired by the transport stream processing unit 103 or the analog EPG processing circuit 106. That is, the EPG processing unit 110 has a function of updating EPG information stored in the memory unit 111 using the EPG information supplied from the transport stream processing unit 103 or the analog EPG processing circuit 106.

The EPG processing unit 110 also has a function of causing the display unit 108 to display the EPG information stored in the memory unit 111 by the OSD function of the signal processing unit 107. More specifically, upon receiving an EPG information display request from the control unit 100, the EPG processing unit 110 reads out the EPG information from the memory unit 111 and supplies it to the signal processing unit 107. The signal processing unit 107 generates display data based on the EPG information received from the EPG processing unit 110 using the OSD function and causes the display unit 108 to display the generated display data.

The EPG processing unit 110 also has a function of requesting the latest EPG information of the STB 2 connected to the TV 1 via the EPG data communication circuit 112 and the control terminal 113. In this case, the EPG processing unit 110 requests the STB 2 to acquire the EPG information and receives, from the STB 2, EPG information acquired by the STB 2 in response to the request. For example, when the digital tuner 101 or analog tuner 104 is receiving the broadcast wave of a specific channel for a long time, the EPG processing unit 110 requests, via the EPG data communication circuit 112 and the control terminal 113, the STB 2 to acquire EPG information.

The EPG processing unit 110 also has a function of conversely acquiring EPG information in response to an EPG information acquisition request from the STB 2. More specifically, upon receiving an EPG information acquisition request from the STB 2 via the EPG data communication circuit 112 and the control terminal 113, the EPG processing unit 110 acquires EPG information using the above-described units and transmits the acquired EPG information to the STB 2.

The external input terminal 114 supplies a video signal and audio signal supplied from the STB 2 to the signal processing unit 107. This allows the signal processing unit 107 to cause the display unit 108 or sound output unit 109 to display or output the video signal and audio signal supplied from the STB 2 serving as an external device to the TV 1 via the external input terminal 114.

The outline of a digital broadcasting reception process in the TV 1 will be described.

The TV 1 has a function of displaying digital broadcasting on the display unit 108 using the control unit 100, digital tuner 101, demodulator 102, transport stream processing unit 103, signal processing unit 107, and the like.

Digital broadcast waves received by the antenna 3 are input to the digital tuner 101 of the TV 1. Based on a control signal from the control unit 100, the digital tuner 101 selects the broadcast signal of a desired broadcasting station (channel) from the digital broadcast waves received by the antenna 3. The demodulator 102 demodulates the digital broadcast wave of the channel selected by the digital tuner 101.

Assume that the signal demodulated from the digital broadcast wave of the channel selected by the digital tuner 101 is an MPEG TS signal. The transport stream processing unit 103 executes a TS decoding process of the MPEG TS signal supplied from the demodulator 102. The transport stream processing unit 103 outputs a digital video signal and audio signal obtained by the TS decoding process to the signal processing unit 107. The signal processing unit 107 causes the display unit 108 to display a video image based on the video signal contained in the received broadcast signal and causes the sound output unit 109 to output sound based on the audio signal.

The TV 1 also has a function of acquiring EPG information from digital broadcasting using the control unit 100, digital tuner 101, demodulator 102, EPG processing unit 110, and the like.

Assume that EPG information contained in a digital broadcast wave indicates, e.g., the program information of each broadcasting station contained in the digital broadcast wave of the channel. To receive such EPG information, the control unit 100 controls the digital tuner 101 to, e.g., periodically receive the broadcast wave of each channel. The digital broadcast wave of each channel received by the digital tuner 101 is demodulated by the demodulator 102 and supplied to the transport stream processing unit 103. The transport stream processing unit 103 outputs, to the EPG processing unit 110, the EPG information of each broadcasting station obtained by the above-described TS decoding process. The EPG processing unit 110 executes a process of, e.g., saving the EPG information extracted from the digital broadcast wave in the memory unit 111.

The arrangement shown in FIG. 1 includes only one tuner to receive a digital broadcast wave. For this reason, if the digital tuner 101 is busy (for example, when the digital broadcasting of a specific broadcasting station is being displayed for a long time), the control unit 100 does not control to switch the channel to acquire EPG information. That is, in the TV 1, when the digital tuner 101 is being used to receive the broadcast wave of a specific channel, a process of acquiring EPG information from the digital broadcast wave of another channel is inhibited.

The outline of an analog broadcasting reception process in the TV 1 will be described next.

The TV 1 has a function of displaying analog broadcasting on the display unit 108 using the control unit 100, analog tuner 104, analog demodulator 105, signal processing unit 107, and the like.

Analog broadcast waves received by the antenna 3 are input to the analog tuner 104 of the TV 1. Based on a control signal from the control unit 100, the analog tuner 104 selects the broadcast signal of a desired broadcasting station (channel) from the analog broadcast waves received by the antenna 3. The analog demodulator 105 demodulates the broadcast wave of the channel selected by the analog tuner 104. The analog demodulator 105 outputs the demodulated signal to the signal processing unit 107 as a broadcast signal (video signal and audio signal). The signal processing unit 107 causes the display unit 108 to display a video image based on the video signal contained in the received broadcast signal and causes the sound output unit 109 to output sound based on the audio signal.

The TV 1 also has a function of acquiring EPG information from analog broadcasting using the control unit 100, analog tuner 104, analog demodulator 105, analog EPG processing circuit 106, EPG processing unit 110, and the like.

Assume that EPG information contained in analog broadcasting is contained in the broadcast wave of a specific channel in a specific time zone. In this case, to receive EPG information, the control unit 100 controls the analog tuner 104 to receive the broadcast wave of a predetermined channel in a predetermined time zone. The broadcast wave of a specific channel received by the analog tuner 104 is demodulated by the analog demodulator 105. The analog EPG processing circuit 106 extracts EPG information from the signal demodulated by the analog demodulator 105. The analog EPG processing circuit 106 supplies the extracted EPG information to the EPG processing unit 110. The EPG processing unit 110 executes a process of, e.g., saving the EPG information supplied from the analog EPG processing circuit 106 in the memory unit 111.

The arrangement shown in FIG. 1 includes only one tuner to receive analog broadcasting. For this reason, if the analog tuner 104 is busy (for example, when the analog broadcasting of another channel is being displayed), the control unit 100 does not control to switch the channel to be received to acquire EPG information. That is, in the TV 1, when the analog tuner 104 is being used to receive the broadcast wave of another channel, a process of acquiring EPG information from an analog broadcasting wave is inhibited.

The arrangement of the peripheral device (STB) 2 will be described next.

As shown in FIG. 1, the STB 2 includes a control unit 200, digital tuner 201, demodulator 202, transport stream (TS) processing unit 203, analog tuner 204, analog demodulator 205, analog EPG processing circuit 206, signal processing unit 207, video output terminal 208, audio output terminal 209, EPG processing unit 210, memory unit 211, EPG data communication circuit 212, and control terminal 213.

The control unit 200, digital tuner 201, demodulator 202, transport stream processing unit 203, analog tuner 204, analog demodulator 205, analog EPG processing circuit 206, signal processing unit 207, EPG processing unit 210, memory unit 211, EPG data communication circuit 212, and control terminal 213 have the same functions as the control unit 100, digital tuner 101, demodulator 102, transport stream (TS) processing unit 103, analog tuner 104, analog demodulator 105, analog EPG processing circuit 106, signal processing unit 107, EPG processing unit 110, memory unit 111, EPG data communication circuit 112, and control terminal 113, respectively, and a detailed description thereof will not be repeated.

The video output terminal 208 serves as an interface for externally outputting a video signal. The audio output terminal 209 serves as an interface for externally outputting an audio signal. In the example shown in FIG. 1, the video output terminal 208 and audio output terminal 209 are connected to the external input terminal 114 of the TV 1. Hence, a video signal and audio signal processed by the signal processing unit 207 of the STB 2 are input to the external input terminal of the TV 1 via the video output terminal 208 and audio output terminal 209, respectively. In the TV 1, the signal processing unit 107 causes the display unit 108 to display a video image based on the video signal input from the STB 2 to the external input terminal 114 and causes the sound output unit 109 to output sound based on the audio signal from the STB 2.

An EPG information acquisition process (update process) will be described next.

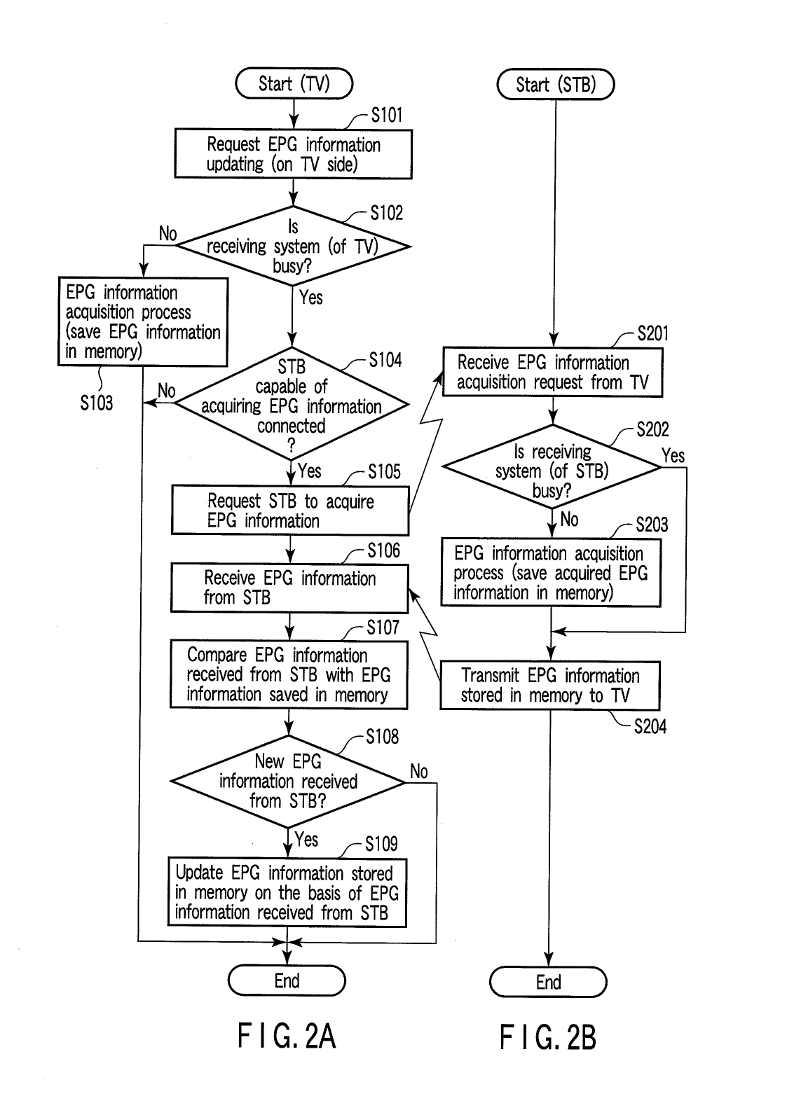

FIG. 2A is an exemplary flowchart for explaining an EPG information acquisition process (update process) in the TV 1. FIG. 2B is an exemplary flowchart for explaining a process on the side of the STB 2 according to the EPG information acquisition process in the TV 1. The processes shown in FIGS. 2A and 2B assume that the TV 1 serves as a first TV set, and the STB 2 serves as a second TV set. However, the processes to be described below can be implemented even when the TV 1 and the STB 2 are exchanged.

First, the control unit 100 of the TV 1 starts the EPG information acquisition process (update process) every preset period of time (periodically) or based on an EPG information acquisition request from the user via a user interface (not shown) (step S101). When the EPG information update process starts, the control unit 100 confirms whether the demodulator 102 or the analog demodulator 105 is busy (step S102). For example, when the broadcast wave of a specific channel is being received (when the user is viewing broadcasting of a specific broadcasting station), the control unit 100 determines that the digital broadcast wave receiving system (digital tuner 101 and demodulator 102) or analog broadcast wave receiving system (analog tuner 104 and analog demodulator 105) is busy. The following description will be made assuming that the digital broadcast wave of each channel contains the EPG information of the broadcasting station, and the EPG information of each broadcasting station is acquired from the digital broadcast wave.

Upon determining that the receiving system of the TV 1 is not busy (NO in step S102), the control unit 100 acquires EPG information from the digital broadcast wave of each channel using the digital broadcast wave receiving system (101 and 102) (step S103). When the EPG information of each broadcasting station is acquired by the EPG information acquisition process, the EPG processing unit 110 saves the acquired EPG information of each broadcasting station in the memory unit 111. The memory unit 111 thus stores the latest EPG information.

Upon determining that the receiving system of the TV 1 is busy (YES in step S102), the control unit 100 determines whether the STB 2 having the EPG information acquisition function is connected via the control terminal 113 (step S104). Upon determining that the STB 2 having the EPG information acquisition function is not connected (NO in step S104), the control unit 100 finishes the EPG information update process.

Upon determining that the STB 2 having the EPG information acquisition function is connected (YES in step S104), the control unit 100 requests the STB 2 to acquire the latest EPG information (step S105). For example, the control unit 100 transmits a command for requesting (asking) acquisition of the latest EPG information to the STB 2 via the EPG processing unit 110, EPG data communication circuit 112, and control terminal 113.

The control unit 200 receives the latest EPG information acquisition request from the TV 1 via the control terminal 213, EPG data communication circuit 212, and EPG processing unit 210 (step S201). Upon receiving the EPG information acquisition request from the TV 1, the control unit 200 confirms whether the demodulator 202 or the analog demodulator 205 is busy (step S202). For example, when the digital broadcast wave of a specific channel is being received (for example, when the digital broadcasting of a specific channel is being recorded in accordance with a recording reservation made by the user), the control unit 200 determines that the digital broadcast wave receiving system (digital tuner 201 and demodulator 202) is busy.

Upon determining that the receiving system of the STB 2 is not busy (NO in step S202), the control unit 200 acquires the EPG information of each broadcasting station using the digital broadcast wave receiving system (201 and 202) (step S203). When the EPG information of each broadcasting station is acquired by the EPG information acquisition process, the EPG processing unit 210 saves the acquired EPG information in the memory unit 211. The memory unit 211 thus stores the latest EPG information. When the latest EPG information is saved in the memory unit 211 by the EPG information acquisition process, the EPG processing unit 210 transmits the EPG information saved in the memory unit 211 to the TV 1 via the EPG data communication circuit 212 and control terminal 213 (step S204).

Upon determining that the receiving system of the STB 2 is busy (YES in step S202), the control unit 200 transmits EPG information already stored in the memory unit 211 to the TV 1 without executing the EPG information acquisition process (step S204). If the receiving system of the STB 2 is busy (i.e., if the situation does not allow EPG information acquisition) the control unit 200 of the STB 2 may transmit information representing that EPG information acquisition was impossible as a response to the EPG information acquisition request from the TV 1.

The EPG processing unit 110 of the TV 1 receives, via the control terminal 113 and EPG data communication circuit 112, the EPG information transmitted from the STB 2 to the TV 1 in step S204 (step S106). Upon receiving the EPG information from the STB 2, the EPG processing unit 110 of the TV 1 compares the EPG information received from the STB 2 with the EPG information saved in the memory unit 111 (step S107). This comparison is done to determine whether the EPG information received from the STB 2 is newer than the EPG information saved in the memory unit 111.

Upon determining that the EPG information received from the STB 2 is newer than the EPG information saved in the memory unit 111, the EPG processing unit 110 updates the EPG information stored in the memory unit 111 on the basis of the EPG information received from the STB 2 (step S109).

Note that if the STB 2 has received the EPG information of all broadcasting stations from the broadcast waves of all channels, the EPG information received from the STB 2 is supposed to contain the latest information of all broadcasting stations (newer than the information stored in the memory unit 111). In this case, the EPG processing unit 110 may omit the comparison process in step S107 and update the EPG information of each broadcasting station stored in the memory unit 111 on the basis of the EPG information received from the STB 2.

If the STB 2 has acquired the EPG information of only some of the broadcasting stations or transmitted the EPG information stored in the memory unit 211 to the TV 1 without executing the EPG information acquisition process, of the EPG information received from the STB 2, pieces of information for only some broadcasting stations may be newer than the information stored in the memory unit 111. In such a case, the EPG processing unit 110 may update the EPG information stored in the memory unit 111 on the basis of the pieces of new information contained in the EPG information received from the STB 2.

The processes shown in FIGS. 2A and 2B can also be executed even when the TV 1 and the STB 2 are exchanged. More specifically, when the state of the STB 2 does not allow EPG information acquisition, the STB may cause the TV 1 to acquire EPG information by controlling the EPG information acquisition function of the TV 1, and update the EPG information stored in the memory unit 211 of the STB 2 on the basis of the EPG information acquired by the TV 1.

As described above, in the system formed by connecting the TV 1 and the STB 2, the TV 1 determines, in updating EPG information, whether the state of the TV allows EPG information acquisition from a broadcast wave. If the state does not allow EPG information acquisition, the TV 1 requests the STB 2 to acquire EPG information. When the EPG information acquisition request is received from the TV 1, and the state of the STB allows EPG information acquisition from a broadcast wave, the STB 2 acquires EPG information and transmits the acquired EPG information (latest EPG information) to the TV 1. The TV 1 updates the EPG information saved in the memory unit 111 on the basis of the EPG information received from the STB 2.

That is, in the system formed by connecting the TV 1 and the STB 2, even when one device cannot acquire EPG information, the device can acquire latest EPG information by causing the other device to acquire it. As a result, even when only a specific channel is being received for a long time, the TV 1 or the STB 2 can update the EPG information of all channels to the latest EPG information.

The system described in the embodiment can be implemented only by connecting the TV 1 and the STB 2 via, e.g., a communication line without building a large-scale network or installing a dedicated data server. The system described in the embodiment can be formed by the TV 1 or the STB 2 having only one receiving system for various kinds of broadcast waves. That is, the above-described system is inexpensive and requires no complex settings such as network setup.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A TV set, comprising:
a demodulation module configured to demodulate a broadcast wave;
an extraction module configured to extract program information from a signal demodulated by the demodulation module;
a memory configured to store the program information;
an interface configured to communicate with another TV set having a function of extracting the program information from the broadcast wave;
a control module configured to cause the other TV set to acquire program information to be updated, when the demodulation module fails to acquire the broadcast wave containing the program information; and
a processing module configured to update the program information stored in the memory based on the program information acquired by the other TV set.

2. A TV set of claim 1, wherein the control module is configured to determine whether or not the demodulation module is able to acquire the broadcast wave containing the program information by determining whether the demodulation module is demodulating a broadcast wave other than the broadcast wave containing the updated program information.

3. A TV set of claim 1, wherein the control module is configured to determine whether to start updating the program information stored in the memory either every predetermined time or upon a request from a user.

4. A TV set of claim 1, wherein the processing module is configured to update the program information stored in the memory to new information by comparing the program information stored in the memory with the program information acquired by the other TV set.

5. A TV set of claim 1, further comprising a display module configured to display a video signal obtained by causing the demodulation module to demodulate the broadcast wave.

6. A TV broadcasting receiving system comprising a first TV set and a second TV set,
the first TV set comprising:
a first demodulation module configured to demodulate a broadcast wave;
a first extraction module configured to extract program information from a signal demodulated by the first demodulation module;
a first memory configured to store the program information;
a first interface configured to communicate with the second TV set;
a first control module configured to request the second TV set to acquire program information to be updated, when the first demodulation module fails to acquire the broadcast wave containing the program information; and
a processing module configured to update the program information stored in the first memory based on the program information received from the second TV set in accordance with the program information acquisition request, and
the second TV set comprising:
a second demodulation module configured to demodulate a broadcast wave
a second extraction module configured to extract program information from a signal demodulated by the second demodulation module;
a second interface configured to communicate with the first TV set; and
a second control module configured to cause the second extraction module to extract program information from the signal demodulated by the second demodulation module and to transmit the extracted program information to the first TV set, upon a program information acquisition request from the first TV set via the second interface.

7. A system of claim 6, wherein the first control module is configured to determine whether the first demodulation module is able to acquire the broadcast wave containing the program information by determining whether the first demodulation module is demodulating a broadcast wave other than the broadcast wave containing updated program information.

8. A system of claim 6, wherein the first control module is configured to determine whether to start updating the program information stored in the first memory either every predetermined time or upon a request from a user.

9. A system of claim 6, wherein the processing module is configured to update the program information stored in the first memory to new information by comparing the program information stored in the first memory with the program information received from the second TV set.

10. A system of claim 6, wherein
the second TV set further comprises a second memory configured to store program information,
the second control module configured to cause the second extraction module to extract the program information from the signal demodulated by the second demodulation module and to transmit the extracted program information to the first TV set when the program information acquisition request is received from the first TV set via the second interface, and the second demodulation module is able to acquire the broadcast wave containing the program information and to transmit the program information stored in the second memory to the first TV set when the second demodulation module fails to acquire the broadcast wave containing the program information; and
the processing module configured to update the program information stored in the first memory to new information by comparing the program information stored in the first memory with the program information received from the second TV set.

11. A program information acquisition method used in a TV set comprising a demodulation module configured to demodulate a broadcast wave, an extraction module configured to extract program information from a signal demodulated by the demodulation module, and a memory configured to store the program information, the method comprising:
causing another TV set comprising a function of extracting program information from a broadcast wave to acquire the program information when the demodulation module fails to demodulate a broadcast wave containing program information to be updated; and
updating the program information stored in the memory based on the program information acquired by the other TV set.
